(19) United States
(12) Patent Application Publication
(10) Pub. No.: US 2026/0281816 A1
(43) Pub. Date: Sep. 17, 2026

(54) SYSTEMS AND METHODS FOR EFFICIENT BINDING SUPPORT FUNCTION DISCOVERY IN A WIRELESS NETWORK

(71) Applicant: Verizon Patent and Licensing Inc., Basking Ridge, NJ (US)

(72) Inventors: Violeta Cakulev, Milburn, NJ (US); Lixia Yan, Basking Ridge, NJ (US); Ali Imdad Malik, East Brunswick, NJ (US); Robert Avanes, Roanoke, TX (US); Hossein M. Ahmadi, Parsippany, NJ (US)

(73) Assignee: Verizon Patent and Licensing Inc., Basking Ridge, NJ (US)

(21) Appl. No.: 19/080,052

(22) Filed: Mar. 14, 2025

(51) Int. Cl. H04W 28/08; H04W 28/06

(52) U.S. Cl. CPC H04W 28/0925; H04W 28/06

(57) ABSTRACT

A device described herein may maintain one or more policies associated with a particular User Equipment (“UE”); provide, based on maintaining the one or more policies associated with the particular UE and to a Binding Support Function (“BSF”) of a wireless network, an indication associating the device with the particular UE; and provide, to a Unified Data Repository (“UDR”) of the wireless network, an association between the particular UE and the BSF, wherein the UDR provides information associating the particular UE and the BSF to one or more Network Functions (“NFs”) of the wireless network. The device may include a Policy Control Function (“PCF”) of the wireless network. The BSF may be a particular BSF instance out of a set of BSF instances implemented by the wireless network. The BSF may maintain information indicating that the device maintains one or more policies associated with the particular UE.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. Wireless networks may include Network Functions (“NFs”), such as Policy Control Functions (“PCFs”), that enforce policies, such as Quality of Service (“QoS”) policies, access policies, and/or other policies in order to maintain network security, performance, stability, and/or other factors. NFs of the wireless network may be implemented in a distributed or containerized manner, such that multiple instances of the same type of NF may be present in the wireless network. For example, multiple different PCF instances may be implemented in the wireless network.

The wireless network may include an NF, such as a Binding Support Function (“BSF”), which maintains information associating particular PCF instances with particular UEs or communication sessions (e.g., protocol data unit (“PDU”) sessions). BSFs may also be implemented in a distributed or containerized manner, such that multiple BSF instances may be present in the wireless network. NFs of the wireless network, such as “consumer” NFs that may seek to identify which PCF instance is associated with a particular UE or communication session may, in some scenarios, issue queries to some or all BSF instances of the wireless network, in order to attempt to identify which (if any) of the BSF instances maintains information associating the particular UE or communication session with a particular PCF instance.

### BRIEF DESCRIPTION OF THE DRAWINGS

FIG. 1 illustrates an example overview of one or more embodiments described herein;

FIG. 2 illustrates an example of updating a UE information repository of a wireless network with information associating a BSF to a UE and/or a communication session, in accordance with some embodiments;

FIGS. 3, 4A, and 4B illustrate example data structures that may be used in accordance with some embodiments;

FIG. 5 illustrates an example BSF discovery procedure in accordance with some embodiments;

FIG. 6 illustrates an example process for an efficient BSF discovery procedure in a wireless network, in accordance with some embodiments;

FIGS. 7 and 8 illustrate example environments in which one or more embodiments, described herein, may be implemented;

FIG. 9 illustrates an example arrangement of a radio access network (“RAN”), in accordance with some embodiments; and

FIG. 10 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide for an efficient BSF discovery procedure in a wireless network. As discussed herein, an information repository of a wireless network, such as a Unified Data Repository (“UDR”), a Unified Data Management function (“UDM”), and/or some other suitable network element, may maintain information associating particular UEs and/or communication sessions (e.g., PDU sessions) with respective BSFs (e.g., BSF instances). In other words, out of a set of multiple BSF instances implemented by the wireless network, a particular BSF may maintain information associated with a particular UE, such as information indicating a particular PCF instance (e.g., out of a set of PCF instances) that maintains or enforces policies associated with the particular UE. Maintaining information, that associates a particular UE or communication session with a particular BSF (e.g., a particular BSF instance) that maintains PCF association information for the particular UE or communication session, may allow for a more efficient discovery process of the particular BSF. For example, another NF of the wireless network (e.g., a “consumer” NF) that uses the PCF association information (e.g., to communicate with a particular PCF that maintains or enforces policies for a given UE or communication session) may be able to quickly identify the appropriate BSF instance, without needing to query multiple BSF instances, thus enhancing overall efficiency of the wireless network (e.g., by eliminating latency or delay related to a BSF discovery procedure in which multiple BSF instances are queried).

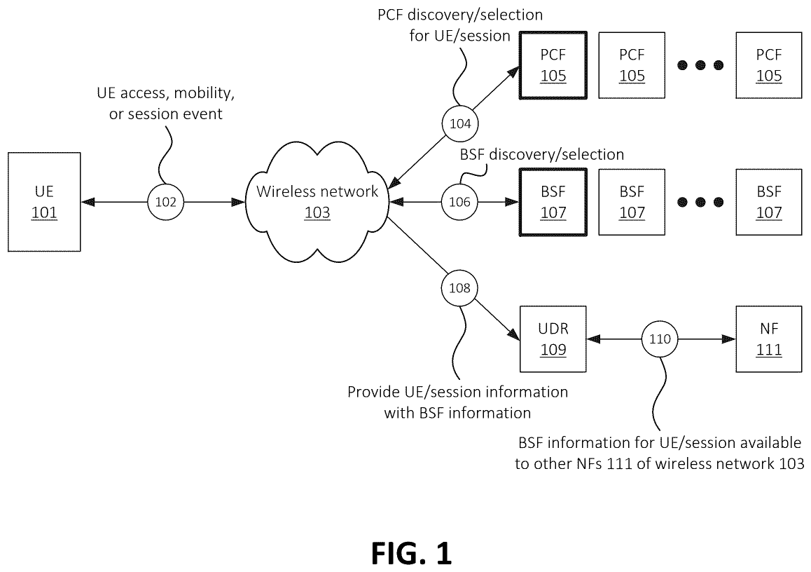

As shown in FIG. 1, for example, a particular UE 101 may be communicatively coupled to a particular wireless network 103, which may be or may include a Fifth Generation (“5G”) core (“5GC”) network, an Evolved Packet Core (“EPC”), a converged core network (e.g., that implements functionality of a 5GC, an EPC, and/or some other suitable type of core network), or the like. Wireless network 103 may include a set of PCF instances 105 (also referred sometimes referred to as “PCFs” 105), a set of BSF instances 107 (also sometimes referred to as “BSFs” 107), UDR 109, and one or more other NFs 111.

At some point, wireless network 103 may detect, initiate, receive, or participate in (at 102) a UE access event or procedure, a UE mobility event or procedure, a communication session event or procedure, and/or some other suitable type of event or procedure. A UE access event or procedure may include, for example, a UE connection or registration request, a request for UE 101 to access a RAN of wireless network 103, a request for UE 101 to access a particular network slice of wireless network 103, or the like. A mobility event or procedure may include UE 101 moving from one geographical location to another, a UE handover procedure, or the like. A communication session event or procedure may include a session establishment request or procedure (e.g., a PDU session establishment request), a session modification request or procedure (e.g., a PDU session modification request), and/or some other suitable type of event or procedure.

In some embodiments, the UE access event or procedure, UE mobility event or procedure, communication session event or procedure, etc. may performed by, handled by, initiated by, and/or may otherwise involve one or more NFs of wireless network 103. For example, an Access and Mobility Management Function (“AMF”) of wireless network 103 may perform, handle, initiate, etc. access and/or mobility procedures, and a Session Management Function (“SMF”) of wireless network may perform, handle, initiate, etc. session-based procedures.

As part of, or pursuant to, the UE event or procedure (identified at 102), wireless network 103 may perform (at 104) a PCF discovery and/or selection, in order to select a particular PCF instance 105 out of a set of PCF instances 105. Wireless network 103 may select the particular PCF instance 105 based on factors such as latency, geographical location, load or performance of PCF instances 105, and/or other suitable factors. Once the particular PCF instance 105 has been selected, the particular PCF instance 105 may be configured to obtain, update, enforce, etc. policies associated with UE 101. For example, the particular PCF instance 105 may obtain, update, enforce, etc. access policies, mobility policies, session policies, or the like. As discussed below, multiple PCF instances 105 may be selected or designated for a particular UE 101. For example, a first PCF instance 105 may maintain, enforce, etc. access and/or mobility policies for UE 101 (also referred to as an “AM-PCF” and/or a “UE-PCF”) and a second PCF instance 105 may maintain, enforce, etc. session-based policies (also referred to as an “SM-PCF”) for communication sessions associated with UE 101. In some implementations, one or more policies, maintained by one or more PCF instances 105, may be UE-specific policies (e.g., policies that are applicable to a specific UE or a specific group of UEs).

Additionally, once a particular PCF instance 105 has been selected (or multiple PCF instances 105 have been selected), wireless network 103 may perform (at 106) a BSF discovery and/or selection procedure, in order to identify one or more particular BSF instances 107 to maintain information associating UE 101 (and/or one or more communication sessions associated with UE 101) at the selected BSF instance (or instances) 107. For example, as discussed below, a selected BSF instance 107 may maintain information associating UE 101 with one or more respective PCF instances 105, where such PCF instances 105 maintain, enforce, etc. policies associated with UE 101.

In accordance with some embodiments, UDR 109 may receive (at 108) information associating UE 101 (and/or one or more communication sessions associated with UE 101) with the respective BSF instance (or instances) 107 that maintain information associating such UE 101 and/or communication sessions with one or more respective PCFs 105.

In this manner, one or more NFs 111 (e.g., consumer NFs 111) may be able to efficiently obtain (at 110) BSF information for UE 101 and/or for one or more communication sessions associated with UE 101. For example, NF 111 may output a request to UDR 109, where such request includes one or more UE identifiers (e.g., a Mobile Directory Number (“MDN”), an International Mobile Subscriber Identity (“IMSI”) value, an International Mobile Station Equipment Identity (“IMEI”) value, a Subscription Permanent Identifier (“SUPI”), a Globally Unique Temporary Identifier (“GUTI”), an Internet Protocol (“IP”) address, and/or other one or more other suitable identifiers). Additionally, or alternatively, NF 111 may output a request to UDR 109, where such request includes one or more communication session identifiers, such as one or more PDU session identifiers. In some embodiments, the request from NF 111 to UDR 109 may be a one-time request for the information. In some embodiments, the request from NF 111 to UDR 109 may include an ongoing request for updates, such as a subscription request, based on which UDR 109 may provide such information to NF 111 when such information is provided to UDR 109, updated at UDR 109, or the like. As discussed below, NF 111 may utilize the information, associating UE 101 with a given BSF 107, in order to query such BSF 107 for PCF information associated with UE 101. In this manner, NF 111 may relatively quickly identify which PCF instance (or instances) 105 maintain, enforce, etc. policies associated with UE 101. NF 111 may communicate with such PCF instance (or instances) 105 for policy-based procedures, such as updating policies associated with UE 101, obtaining network analytics or diagnostic information from PCF instance 105, facilitating handovers of UE 101 (e.g., from a 5GC to an EPC), and/or in other situations.

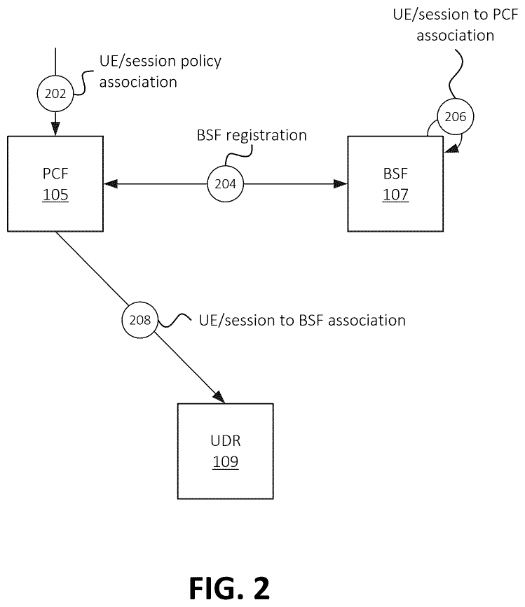

FIG. 2 illustrates an example procedure of updating UDR 109 with BSF information associated with a particular UE 101 or communication session. In the example of FIG. 2, PCF 105 may perform (at 202) a UE and/or session policy association procedure. As one example, such procedure may include an access or mobility procedure initiated by or otherwise involving an AMF. PCF 105 may, for example, receive an Npcf_UEPolicyControl_Create Request message or some other suitable type of message from the AMF, and may obtain, maintain, enforce, etc. one or more UE access and/or mobility policies based on such request. As another example, the UE and/or session policy association procedure may include a session-based procedure initiated by or otherwise involving an SMF. PCF 105 may, for example, receive an Npcf_SMPolicyControl_Create Request message or some other suitable type of message from the SMF, and may obtain, maintain, enforce, etc. one or more session-based policies based on such request.

As noted above, PCF 105 and/or one or more other elements of wireless network 103 may initiate a discovery and/or selection procedure, in which a particular BSF instance 107 is selected to maintain information associating the particular PCF 105 (e.g., a particular PCF instance 105) with UE 101 and/or a communication session associated with UE 101. PCF 105 may accordingly be registered (at 204) with BSF 107, and BSF 107 may accordingly maintain (at 206) an association of UE 101 and/or one or more communication sessions with the particular PCF 105. PCF 105 may, in some embodiments, output (at 208) information to UDR 109, indicating that the particular UE 101 (and/or communication session associated with UE 101) is further associated with BSF 107 (e.g., a particular BSF instance 107). As noted above, this association may denote that the particular BSF 107 maintains information associating the particular UE 101 and/or communication session with a respective PCF instance 105, which maintains or enforces policies for such particular UE 101 and/or communication session.

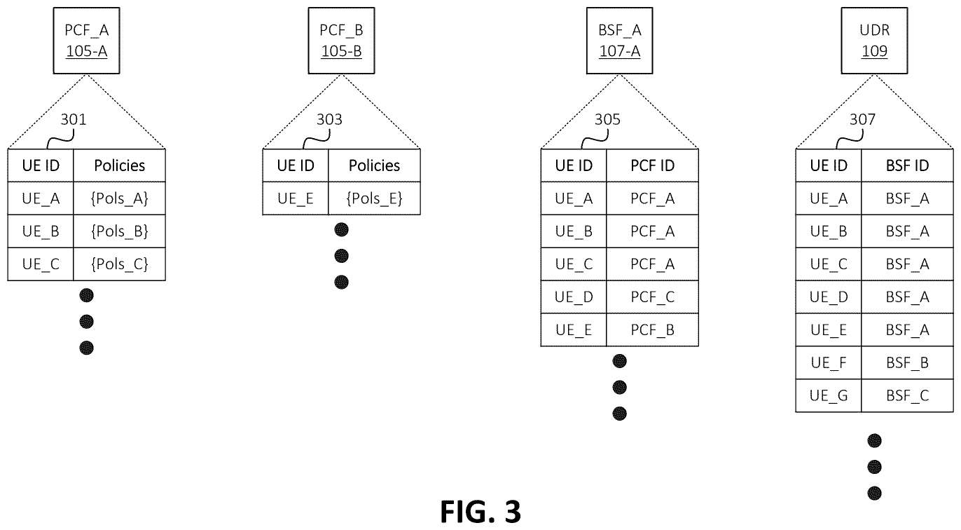

FIG. 3 illustrates example data structures that may be maintained by one or more PCFs 105, BSFs 107, and/or UDR 109 in accordance with some embodiments. As shown, for example, data structure 301 may be maintained by a first PCF instance 105-A (also referred to as “PCF_A”), data structure 303 may be maintained by a second PCF instance 105-B (also referred to as “PCF_A”), data structure 305 may be maintained by a particular BSF instance 107-A (also referred to as “BSF_A”), and data structure 307 may be maintained by UDR 109. As shown, data structure 301 may include respective sets of policies for respective UEs 101. For example, PCF instance 105-A may maintain policy information for UE_A, UE_B, and UE_C (e.g., a set of policies “{Pols_A}” for UE_A, and so on). Similarly, PCF instance 105-B may maintain policy information for UE_E (e.g., a set of policies “{Pols_E}” for UE_E).

As reflected in data structure 305, BSF instance 107-A may maintain information associating UE_A, UE_B, UE_C, UE_D, and UE_E with respective PCF instances 105. For example, such information may indicate that PCF_A (e.g., PCF instance 105-A) maintains policy information for UE_A, UE_B, and UE_C. Additionally, data structure 305 may reflect that PCF_C maintains policy information for UE_D, and that PCF_B maintains policy information for UE_E.

Additionally, as reflected in data structure 307, UDR 109 may maintain information associating UE_A, UE_B, UE_C, UE_D, UE_E, UE_F, and UE_G with respective BSF instances 107. For example, data structure 307 may reflect that BSF_A maintains information (e.g., data structure 305) associating UE_A, UE_B, UE_C, UE_D, and UE_E with respective PCF instances 105. Similarly, data structure 307 may reflect that BSF_B maintains information associating UE_F with one or more respective PCF instances 105, and that BSF_C maintains information associating UE_G with one or more respective PCF instances 105.

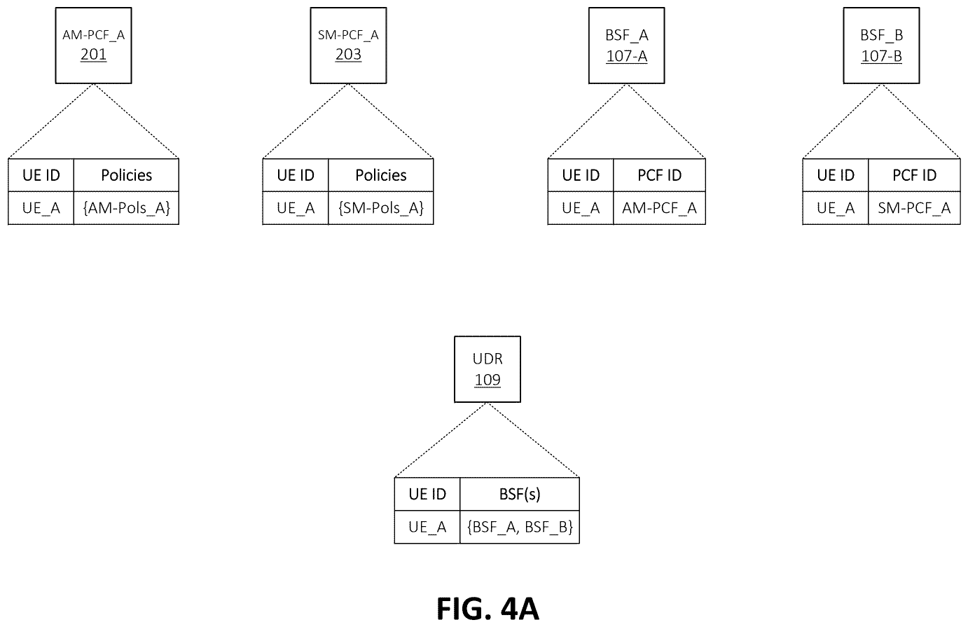

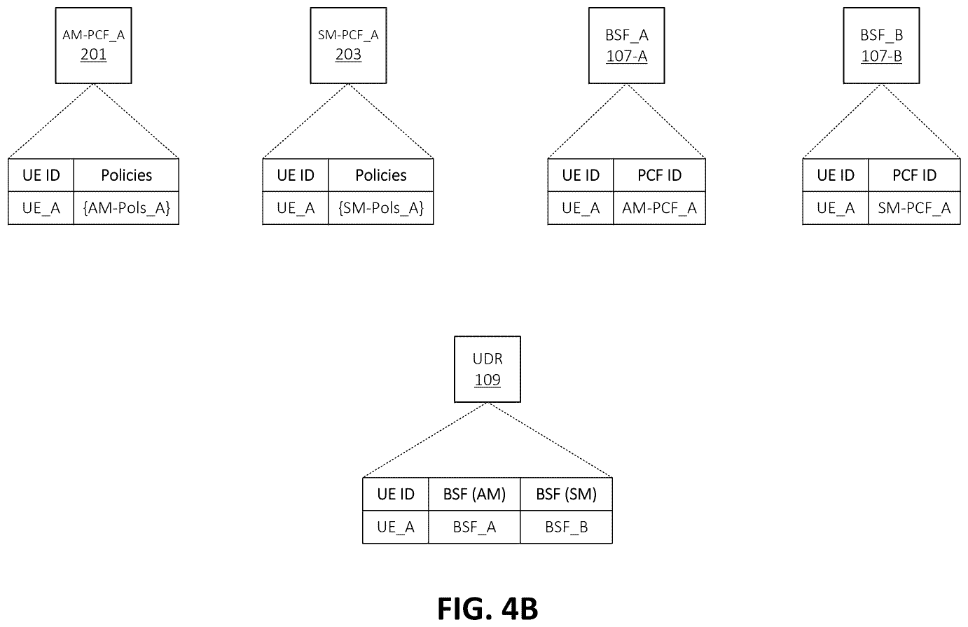

While FIG. 3 is presented in the context of one PCF instance 105 being associated with (e.g., maintaining or enforcing policies for) a given UE 101, similar concepts may apply in implementations where multiple PCF instances 105 are associated with the same UE 101. In some such implementations, different PCF instances 105 or types of PCFs may maintain different policies (or types of policies). For example, as shown in FIGS. 4A and 4B, a particular AM-PCF instance (e.g., AM-PCF_A) 401 may maintain or enforce a particular set of UE access and/or mobility policies (e.g., “{AM-Pols_A}”) for a particular UE 101 (e.g., for UE_A), and a particular SM-PCF instance (e.g., SM-PCF_A) may maintain or enforce a set of session management policies (e.g., “{SM-Pols_A}”) for one or more communication sessions (e.g., PDU sessions) associated with UE_A. In some embodiments, SM-PCF 203 may maintain one or more session identifiers (e.g., PDU session identifiers) in addition to, or in lieu of, one or more identifiers of UE_A. That is, while SM-PCF 203 is shown as maintaining information associating a UE identifier with one or more respective policies, in some embodiments, SM-PCF 203 may maintain information associating one or more session identifiers (in addition to or in lieu of UE identifiers) with the one or more respective policies.

Based on the selection of AM-PCF 201 and SM-PCF 203 to maintain and/or enforce policies associated with UE_A (and/or with one or more communication sessions associated with UE_A), one or more BSF instances 107 may be selected to maintain information associating UE_A with the selected AM-PCF 201 and SM-PCF 203. For example, BSF_A may be selected to maintain information associating UE_A with AM-PCF_A, and BSF_B (e.g., BSF 107-B) may be selected to maintain information associating UE_A with SM-PCF_A. In this sense, the same UE 101 may be associated with multiple different BSF instances 107.

Accordingly, UDR 109 may maintain information associating UE_A with both BSF instances (i.e., associating UE_A with BSF_A and BSF_B). For example, AM-PCF 201 may notify UDR 109 that UE_A is associated with BSF_A, and SM-PCF 203 may notify UDR 109 that UE_A is associated with BSF_B. As similarly discussed above, UDR 109 may maintain information in addition to, or in lieu of UE identifiers, with corresponding BSF information. For example, UDR 109 may maintain information associating SM-PCF 203 with one or more communication session identifiers (e.g., PDU session identifiers) with which UE_A is associated.

As shown in FIG. 4B, UDR 109 may, in some embodiments, maintain information specifying a type of PCF for which a corresponding BSF maintains information for a given UE 101. For example, as similarly shown in FIG. 4A, AM-PCF_A and SM-PCF_A may both maintain or enforce policies for the same UE_A. UDR 109 may maintain information specifying that BSF_A maintains access and/or mobility policies for UE_A, and that BSF_B maintains session management policies for UE_A. In this manner, UDR 109 may be able to respond to queries to consumer NFs that seek to identify PCF instances 105 that maintain or enforce specific types of policies.

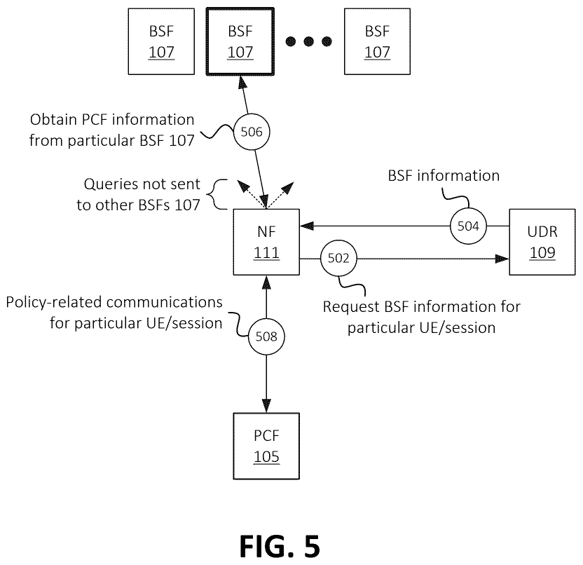

FIG. 5 illustrates an example scenario in which a particular NF 111 (e.g., a “consumer” NF) obtains BSF information for a given UE 101 or a given communication session, in accordance with embodiments described herein. As shown, NF 111 may output (at 502) a request to UDR 109 for BSF information associated with a particular UE 101 and/or a particular communication session. The request may include, for example, an identifier of UE 101 (e.g., IMSI, IMEI, SUPI, GUTI, etc.), a PDU session identifier, or the like. UDR 109 may, in response, provide (at 504) an indication of one or more BSF instances 107 with which the requested UE 101 and/or communication session is associated. NF 111 may accordingly obtain (at 506) PCF information, associated with the requested UE 101 and/or communication session, from the indicated BSF instance 107. As noted above, NF 111 may not need to query or otherwise communicate with other BSF instances 107, since UDR 109 indicated the specific BSF instance (or instances) 107 that maintain information associating the particular UE 101 and/or communication session with a respective PCF instance 105. NF 111 may further proceed to communicate (at 508) with the indicated PCF instance 105.

In one example, NF 111 may include another PCF instance 105, such as in a handover scenario where multiple PCFs or PCF instances 105 (e.g., a target PCF 105 and a source PCF 105) communicate with each other to exchange policy information, such as UE Route Selection Policy (“URSP”) rules associated with UE 101. As another example, NF 111 may obtain policy information associated with UE 101 in order to provide such policy information to a target core network (e.g., in an inter-core network handover scenario). In some such scenarios, the policy information may include consolidated policy information (e.g., from a given AM-PCF and a given SM-PCF), such as in scenarios where a target core network does not implement multiple different types of PCFs, or implements different types of PCFs than the source core network.

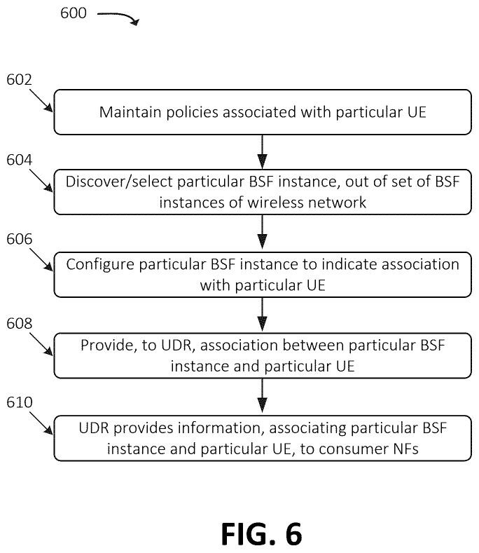

FIG. 6 illustrates an example process 600 for an efficient BSF discovery procedure in a wireless network, in accordance with some embodiments. In some embodiments, some or all of process 600 may be performed by a particular PCF 105. In some embodiments, an AM-PCF, an SM-PCF, a UE-PCF, and/or one or more other devices may perform some or all of process 600 in concert with, and/or in lieu of, PCF 105.

As shown, process 600 may include maintaining (at 602) a set of policies associated with a particular UE 101. As discussed above, the policies may include UE access policies, mobility policies, session-based policies, or other types of policies. In some embodiments, PCF 105 (e.g., a particular PCF instance 105) may have been discovered, selected, etc. out of a set of PCF instances 105 implemented by wireless network 103. As such, the particular PCF 105 may obtain, maintain, enforce, etc. the policies associated with UE 101. Further, some or all other PCF instances 105 of wireless network 103 may not maintain the set of policies associated with the particular UE 101. As discussed above, in some situations, multiple PCF instances 105 may maintain, enforce, etc. policies (e.g., different sets of policies) associated with the same UE 101, while other PCF instances 105 may not maintain, enforce, etc. policies associated with such UE 101. In some embodiments, PCF 105 may receive, obtain, etc. the policies associated with UE 101 as part of or pursuant to a UE registration procedure, a session establishment or modification procedure (e.g., to establish or modify one or more communication sessions associated with UE 101), a policy update procedure, a handover procedure, and/or some other suitable procedure or event.

Process 600 may further include discovering and/or selecting (at 604) a particular BSF 107 (e.g., a particular BSF instance 107). For example, PCF 105 may initiate, participate in, perform, etc. a discovery procedure to select the particular BSF instance 107. In some embodiments, PCF 105 may request a selection or discovery of the particular BSF instance 107 from one or more other devices, systems, or NFs, which may provide an indication of the particular BSF instance 107 to PCF 105.

Process 600 may additionally include configuring (at 606) the particular BSF instance 107 to indicate an association between PCF 105 and UE 101. In some embodiments, the association between PCF 105 and UE 101 may include an identifier or locator of PCF 105 (e.g., an Internet Protocol (“IP”) address, a hostname, a device identifier, or the like) and an identifier of UE 101 (e.g., IMSI, IMEI, SUPI, GUTI, etc.). In some embodiments, the association between PCF 105 and UE 101 may include an identifier or locator of PCF 105 and an identifier of one or more communication sessions associated with UE 101, such as one or more PDU session identifiers. In this manner, the particular BSF instance 107 may be queried by other NFs 111 (e.g., “consumer” NFs) using an identifier of UE 101 and/or of a communication session associated with UE 101, and the particular BSF instance 107 may respond with an identifier or locator of PCF 105 that maintains and/or enforces policies associated with UE 101 and/or the communication session.

Process 600 may also include providing (at 608), to UDR 109 of wireless network 103, an association between the particular BSF instance 107 and UE 101. For example, PCF 105 may provide an identifier or locator of the particular BSF instance 107 and an identifier of UE 101. Additionally, or alternatively, PCF 105 may provide an identifier or locator of the particular BSF instance 107 and an identifier (e.g., a PDU session identifier) of one or more communication sessions associated with UE 101. UDR 109 may thus maintain various information regarding UE 101 used by NFs 111 of wireless network 103 to perform variance functionality such as access control, routing, QoS management, etc., where the information maintained by UDR 109 further includes an association between UE 101 and a particular BSF instance 107.

Process 600 may further include providing (at 610), by UDR 109, information associating UE 101 (and/or one or more communication sessions associated with UE 101) to one or more NFs 111 of wireless network 103 (e.g., “consumer” NFs). NF 111 may, for example, include an SMF, an AMF, another PCF 105, and/or some other suitable device or system. In some embodiments, NF 111 may include or may be communicatively coupled to a Network Exposure Function (“NEF”), which selectively provides access to external devices or systems (e.g., devices or systems that are external to wireless network 103). NF 111 may use the provided information to, for example, efficiently discover or identify the particular BSF instance 107 with which UE 101 is associated, and may request an identifier or locator of one or more PCFs 105 that maintain or enforce policies associated with UE 101. As discussed above, the efficient discovery of the particular BSF instance 107, as provided for in some embodiments, may be faster and consume fewer resources than implementations in which NF 111 does not have access to information indicating which particular BSF instance 107, out of a set of potentially numerous BSF instances 107, maintains information associated with UE 101.

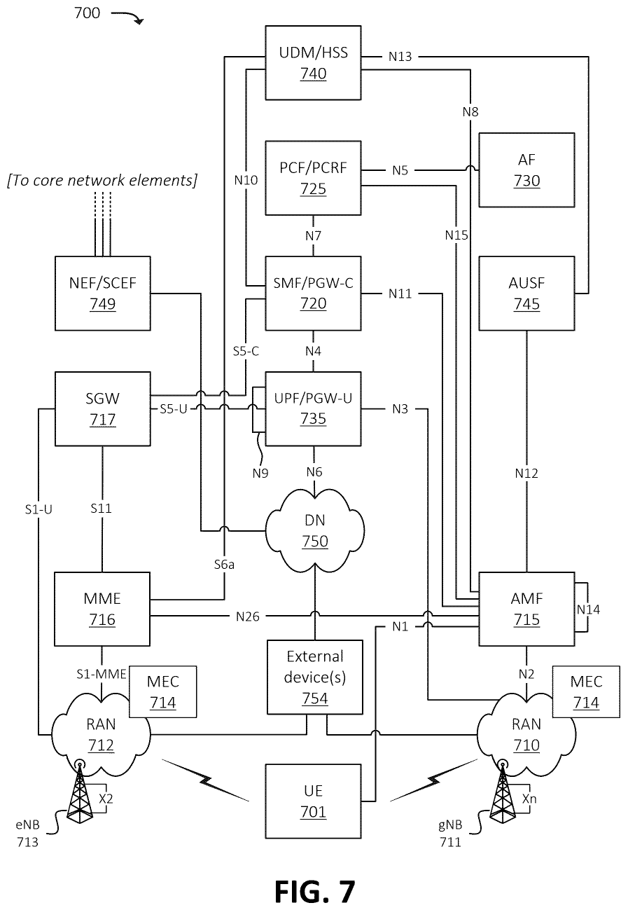

FIG. 7 illustrates an example environment 700, in which one or more embodiments may be implemented. In some embodiments, environment 700 may correspond to a Fifth Generation (“5G”) network, and/or may include elements of a 5G network. In some embodiments, environment 700 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 700 may represent or may include a 5G core (“5GC”). As shown, environment 700 may include UE 701, RAN 710 (which may include one or more Next Generation Node Bs (“gNBs”) 711), RAN 712 (which may include one or more evolved Node Bs (“eNBs”) 713), and various network functions such as Access and Mobility Management Function (“AMF”) 715, Mobility Management Entity (“MME”) 716, Serving Gateway (“SGW”) 717, Session Management Function (“SMF”)/Packet Data Network (“PDN”) Gateway (“PGW”)-Control plane function (“PGW-C”) 720, PCF/Policy Charging and Rules Function (“PCRF”) 725, Application Function (“AF”) 730, User Plane Function (“UPF”)/PGW-User plane function (“PGW-U”) 735, UDM/Home Subscriber Server (“HSS”) 740, Authentication Server Function (“AUSF”) 745, and NEF/Service Capability Exposure Function (“SCEF”) 749. Environment 700 may also include one or more networks, such as Data Network (“DN”) 750. Environment 700 may include one or more additional devices or systems communicatively coupled to one or more networks (e.g., DN 750), such as one or more external devices 754.

The example shown in FIG. 7 illustrates one instance of each network component or function (e.g., one instance of SMF/PGW-C 720, PCF/PCRF 725, UPF/PGW-U 735, UDM/HSS 740, and/or AUSF 745). In practice, environment 700 may include multiple instances of such components or functions. For example, in some embodiments, environment 700 may include multiple “slices” of a core network, where each slice includes a discrete and/or logical set of network functions (e.g., one slice may include a first instance of AMF 715, SMF/PGW-C 720, PCF/PCRF 725, and/or UPF/PGW-U 735, while another slice may include a second instance of AMF 715, SMF/PGW-C 720, PCF/PCRF 725, and/or UPF/PGW-U 735). The different slices may provide differentiated levels of service, such as service in accordance with different Quality of Service (“QoS”) parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. In some implementations, one or more devices of environment 700 may be physically integrated in, and/or may be physically attached to, one or more other devices of environment 700. Alternatively, or additionally, one or more of the devices of environment 700 may perform one or more network functions described as being performed by another one or more of the devices of environment 700.

Additionally, one or more elements of environment 700 may be implemented in a virtualized and/or containerized manner. For example, one or more of the elements of environment 700 may be implemented by one or more Virtualized Network Functions (“VNFs”), Cloud-Native Network Functions (“CNFs”), etc. In such embodiments, environment 700 may include, may implement, and/or may be communicatively coupled to an orchestration platform that provisions hardware resources, installs containers or applications, performs load balancing, and/or otherwise manages the deployment of such elements of environment 700. In some embodiments, such orchestration and/or management of such elements of environment 700 may be performed by, or in conjunction with, the open-source Kubernetes^{®}application programming interface (“API”) or some other suitable virtualization, containerization, and/or orchestration system.

Elements of environment 700 may interconnect with each other and/or other devices via wired connections, wireless connections, or a combination of wired and wireless connections. Examples of interfaces or communication pathways between the elements of environment 700, as shown in FIG. 7, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 7, such as Service-Based Interfaces (“SBIs”), including an Namf interface, an Nudm interface, an Npcf interface, an Nupf interface, an Nnef interface, an Nsmf interface, and/or one or more other SBIs. In some embodiments, environment 700 may be, may include, may be implemented by, and/or may be communicatively coupled to wireless network 103.

UE 701 may include a computation and communication device, such as a wireless mobile communication device that is capable of communicating with RAN 710, RAN 712, and/or DN 750. UE 701 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 701 may send traffic to and/or receive traffic (e.g., user plane traffic) from DN 750 via RAN 710, RAN 712, and/or UPF/PGW-U 735.

RAN 710 may be, or may include, a 5G RAN that implements a 5G RAT and that includes one or more base stations (e.g., one or more gNBs 711), via which UE 701 may communicate with one or more other elements of environment 700. UE 701 may communicate with RAN 710 via an air interface (e.g., as provided by gNB 711). For instance, RAN 710 may receive traffic (e.g., user plane traffic such as voice call traffic, data traffic, messaging traffic, etc.) from UE 701 via the air interface, and may communicate the traffic to UPF/PGW-U 735 and/or one or more other devices or networks. Further, RAN 710 may receive signaling traffic, control plane traffic, etc. from UE 701 via the air interface, and may communicate such signaling traffic, control plane traffic, etc. to AMF 715 and/or one or more other devices or networks. Additionally, RAN 710 may receive traffic intended for UE 701 (e.g., from UPF/PGW-U 735, AMF 715, and/or one or more other devices or networks) and may communicate the traffic to UE 701 via the air interface.

RAN 712 may be, or may include, an LTE RAN that implements an LTE RAT and that includes one or more base stations (e.g., one or more eNBs 713), via which UE 701 may communicate with one or more other elements of environment 700. UE 701 may communicate with RAN 712 via an air interface (e.g., as provided by eNB 713). For instance, RAN 712 may receive traffic (e.g., user plane traffic such as voice call traffic, data traffic, messaging traffic, signaling traffic, etc.) from UE 701 via the air interface, and may communicate the traffic to UPF/PGW-U 735 (e.g., via SGW 717) and/or one or more other devices or networks. Further, RAN 712 may receive signaling traffic, control plane traffic, etc. from UE 701 via the air interface, and may communicate such signaling traffic, control plane traffic, etc. to MME 716 and/or one or more other devices or networks. Additionally, RAN 712 may receive traffic intended for UE 701 (e.g., from UPF/PGW-U 735, MME 716, SGW 717, and/or one or more other devices or networks) and may communicate the traffic to UE 701 via the air interface.

One or more RANs of environment 700 (e.g., RAN 710 and/or RAN 712) may include, may implement, and/or may otherwise be communicatively coupled to one or more edge computing devices, such as one or more Multi-Access/Mobile Edge Computing (“MEC”) devices (referred to sometimes herein simply as a “MECs”) 714. MECs 714 may be co-located with wireless network infrastructure equipment of RANs 710 and/or 712 (e.g., one or more gNBs 711 and/or one or more eNBs 713, respectively). Additionally, or alternatively, MECs 714 may otherwise be associated with geographical regions (e.g., coverage areas) of wireless network infrastructure equipment of RANs 710 and/or 712. In some embodiments, one or more MECs 714 may be implemented by the same set of hardware resources, the same set of devices, etc. that implement wireless network infrastructure equipment of RANs 710 and/or 712. In some embodiments, one or more MECs 714 may be implemented by different hardware resources, a different set of devices, etc. from hardware resources or devices that implement wireless network infrastructure equipment of RANs 710 and/or 712. In some embodiments, MECs 714 may be communicatively coupled to wireless network infrastructure equipment of RANs 710 and/or 712 (e.g., via a high-speed and/or low-latency link such as a physical wired interface, a high-speed and/or low-latency wireless interface, or some other suitable communication pathway).

MECs 714 may include hardware resources (e.g., configurable or provisionable hardware resources) that may be configured to provide services and/or otherwise process traffic to and/or from UE 701, via RAN 710 and/or 712. For example, RAN 710 and/or 712 may route some traffic from UE 701 (e.g., traffic associated with one or more particular services, applications, application types, etc.) to a respective MEC 714 instead of to core network elements of 700 (e.g., UPF/PGW-U 735). MEC 714 may accordingly provide services to UE 701 by processing such traffic, performing one or more computations based on the received traffic, and providing traffic to UE 701 via RAN 710 and/or 712. MEC 714 may include, and/or may implement, some or all of the functionality described above with respect to UPF/PGW-U 735, AF 730, one or more application servers, and/or one or more other devices, systems, VNFs, CNFs, etc. In this manner, ultra-low latency services may be provided to UE 701, as traffic does not need to traverse links (e.g., backhaul links) between RAN 710 and/or 712 and the core network.

AMF 715 may include one or more devices, systems, VNFs, CNFs, etc., that perform operations to register UE 701 with the 5G network, to establish bearer channels associated with a session with UE 701, to hand off UE 701 from the 5G network to another network, to hand off UE 701 from the other network to the 5G network, manage mobility of UE 701 between RANs 710 and/or gNBs 711, and/or to perform other operations. In some embodiments, the 5G network may include multiple AMFs 715, which communicate with each other via the N14 interface (denoted in FIG. 7 by the line marked “N14” originating and terminating at AMF 715).

MME 716 may include one or more devices, systems, VNFs, CNFs, etc., that perform operations to register UE 701 with the EPC, to establish bearer channels associated with a session with UE 701, to hand off UE 701 from the EPC to another network, to hand off UE 701 from another network to the EPC, manage mobility of UE 701 between RANs 712 and/or eNBs 713, and/or to perform other operations.

SGW 717 may include one or more devices, systems, VNFs, CNFs, etc., that aggregate traffic received from one or more eNBs 713 and send the aggregated traffic to an external network or device via UPF/PGW-U 735. Additionally, SGW 717 may aggregate traffic received from one or more UPF/PGW-Us 735 and may send the aggregated traffic to one or more eNBs 713. SGW 717 may operate as an anchor for the user plane during inter-eNB handovers and as an anchor for mobility between different telecommunication networks or RANs (e.g., RANs 710 and 712).

SMF/PGW-C 720 may include one or more devices, systems, VNFs, CNFs, etc., that gather, process, store, and/or provide information in a manner described herein. SMF/PGW-C 720 may, for example, facilitate the establishment of communication sessions on behalf of UE 701. In some embodiments, the establishment of communications sessions may be performed in accordance with one or more policies provided by PCF/PCRF 725.

PCF/PCRF 725 may include one or more devices, systems, VNFs, CNFs, etc., that aggregate information to and from the 5G network and/or other sources. PCF/PCRF 725 may receive information regarding policies and/or subscriptions from one or more sources, such as subscriber databases and/or from one or more users (such as, for example, an administrator associated with PCF/PCRF 725).

AF 730 may include one or more devices, systems, VNFs, CNFs, etc., that receive, store, and/or provide information that may be used in determining parameters (e.g., quality of service parameters, charging parameters, or the like) for certain applications.

UPF/PGW-U 735 may include one or more devices, systems, VNFs, CNFs, etc., that receive, store, and/or provide data (e.g., user plane data). For example, UPF/PGW-U 735 may receive user plane data (e.g., voice call traffic, data traffic, etc.), destined for UE 701, from DN 750, and may forward the user plane data toward UE 701 (e.g., via RAN 710, SMF/PGW-C 720, and/or one or more other devices). In some embodiments, multiple instances of UPF/PGW-U 735 may be deployed (e.g., in different geographical locations), and the delivery of content to UE 701 may be coordinated via the N9 interface (e.g., as denoted in FIG. 7 by the line marked “N9” originating and terminating at UPF/PGW-U 735). Similarly, UPF/PGW-U 735 may receive traffic from UE 701 (e.g., via RAN 710, RAN 712, SMF/PGW-C 720, and/or one or more other devices), and may forward the traffic toward DN 750. In some embodiments, UPF/PGW-U 735 may communicate (e.g., via the N4 interface) with SMF/PGW-C 720, regarding user plane data processed by UPF/PGW-U 735.

UDM/HSS 740 and AUSF 745 may include one or more devices, systems, VNFs, CNFs, etc., that manage, update, and/or store, in one or more memory devices associated with AUSF 745 and/or UDM/HSS 740, profile information associated with a subscriber. In some embodiments, UDM/HSS 740 may include, may implement, may be communicatively coupled to, and/or may otherwise be associated with some other type of repository or database, such as UDR 109. AUSF 745 and/or UDM/HSS 740 may perform authentication, authorization, and/or accounting operations associated with one or more UEs 701 and/or one or more communication sessions associated with one or more UEs 701.

DN 750 may include one or more wired and/or wireless networks. For example, DN 750 may include an Internet Protocol (“IP”)-based PDN, a wide area network (“WAN”) such as the Internet, a private enterprise network, and/or one or more other networks. UE 701 may communicate, through DN 750, with data servers, other UEs 701, and/or to other servers or applications that are coupled to DN 750. DN 750 may be connected to one or more other networks, such as a public switched telephone network (“PSTN”), a public land mobile network (“PLMN”), and/or another network. DN 750 may be connected to one or more devices, such as content providers, applications, web servers, and/or other devices, with which UE 701 may communicate.

External devices 754 may include one or more devices or systems that communicate with UE 701 via DN 750 and one or more elements of 700 (e.g., via UPF/PGW-U 735). External devices 754 may include, for example, one or more application servers, content provider systems, web servers, or the like. External devices 754 may, for example, implement “server-side” applications that communicate with “client-side” applications executed by UE 701. External devices 754 may provide services to UE 701 such as gaming services, videoconferencing services, messaging services, email services, web services, and/or other types of services. Operations described above with respect to a given external device 754 (e.g., in accordance with some embodiments) may be performed by a single device, by a cloud computing system, by one or more devices that implement a virtualized or containerized environment, a collection of devices, etc.

In some embodiments, external devices 754 may communicate with one or more elements of environment 700 (e.g., core network elements) via NEF/SCEF 749. NEF/SCEF 749 include one or more devices, systems, VNFs, CNFs, etc. that provide access to information, APIs, and/or other operations or mechanisms of one or more core network elements to devices or systems that are external to the core network (e.g., to external device 754 via DN 750). NEF/SCEF 749 may maintain authorization and/or authentication information associated with such external devices or systems, such that NEF/SCEF 749 is able to provide information, that is authorized to be provided, to the external devices or systems. For example, a given external device 754 may request particular information associated with one or more core network elements. NEF/SCEF 749 may authenticate the request and/or otherwise verify that external device 754 is authorized to receive the information, and may request, obtain, or otherwise receive the information from the one or more core network elements. In some embodiments, NEF/SCEF 749 may include, may implement, may be implemented by, may be communicatively coupled to, and/or may otherwise be associated with a Security Edge Protection Proxy (“SEPP”), which may perform some or all of the functions discussed above. External device 754 may, in some situations, subscribe to particular types of requested information provided by the one or more core network elements, and the one or more core network elements may provide (e.g., “push”) the requested information to NEF/SCEF 749 (e.g., in a periodic or otherwise ongoing basis).

In some embodiments, external devices 754 may communicate with one or more elements of RAN 710 and/or 712 via an API or other suitable interface. For example, a given external device 754 may provide instructions, requests, etc. to RAN 710 and/or 712 to provide one or more services via one or more respective MECs 714. In some embodiments, such instructions, requests, etc. may include QoS parameters, Service Level Agreements (“SLAs”), etc. (e.g., maximum latency thresholds, minimum throughput thresholds, etc.) associated with the services.

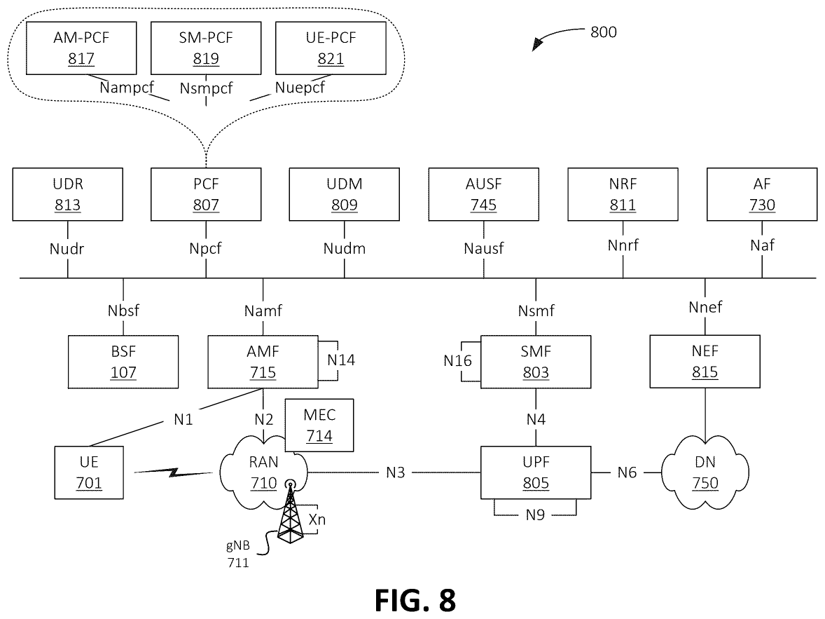

FIG. 8 illustrates another example environment 800, in which one or more embodiments may be implemented. In some embodiments, environment 800 may correspond to a 5G network, and/or may include elements of a 5G network. In some embodiments, environment 800 may correspond to a 5G SA architecture. In some embodiments, environment 800 may include a 5GC, in which 5GC network elements perform one or more operations described herein.

As shown, environment 800 may include UE 701, RAN 710 (which may include one or more gNBs 711 or other types of wireless network infrastructure) and various network functions, which may be implemented as VNFs, CNFs, etc. Such network functions may include AMF 715, SMF 803, UPF 805, PCF 807, UDM 809, AUSF 745, Network Repository Function (“NRF”) 811, AF 730, UDR 813, and NEF 815. Environment 800 may also include or may be communicatively coupled to one or more networks, such as DN 750.

The example shown in FIG. 8 illustrates one instance of each network component or function (e.g., one instance of SMF 803, UPF 805, PCF 807, UDM 809, AUSF 745, etc.). In practice, environment 800 may include multiple instances of such components or functions. For example, in some embodiments, environment 800 may include multiple “slices” of a core network, where each slice includes a discrete and/or logical set of network functions (e.g., one slice may include a first instance of SMF 803, PCF 807, UPF 805, etc., while another slice may include a second instance of SMF 803, PCF 807, UPF 805, etc.). Additionally, or alternatively, one or more of the network functions of environment 800 may implement multiple network slices. The different slices may provide differentiated levels of service, such as service in accordance with different QoS parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. In some implementations, one or more devices of environment 800 may be physically integrated in, and/or may be physically attached to, one or more other devices of environment 800. Alternatively, or additionally, one or more of the devices of environment 800 may perform one or more network functions described as being performed by another one or more of the devices of environment 800.

Elements of environment 800 may interconnect with each other and/or other devices via wired connections, wireless connections, or a combination of wired and wireless connections. Examples of interfaces or communication pathways between the elements of environment 800, as shown in FIG. 8, may include interfaces shown in FIG. 8 and/or one or more interfaces not explicitly shown in FIG. 8. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 800 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 715), an Nudm interface (e.g., indicating communications to be routed to UDM 809), an Npcf interface, an Nupf interface, an Nnef interface, an Nsmf interface, an Nnrf interface, an Nudr interface, an Naf interface, and/or one or more other SBIs. In some embodiments, environment 800 may be, may include, may be implemented by, and/or may be communicatively coupled to wireless network 103.

UPF 805 may include one or more devices, systems, VNFs, CNFs, etc., that receive, route, process, and/or forward traffic (e.g., user plane traffic). As discussed above, UPF 805 may communicate with UE 701 via one or more communication sessions, such as PDU sessions. Such PDU sessions may be associated with a particular network slice or other suitable QoS parameters, as noted above. UPF 805 may receive downlink user plane traffic (e.g., voice call traffic, data traffic, etc. destined for UE 701) from DN 750, and may forward the downlink user plane traffic toward UE 701 (e.g., via RAN 710). In some embodiments, multiple UPFs 805 may be deployed (e.g., in different geographical locations), and the delivery of content to UE 701 may be coordinated via the N9 interface. Similarly, UPF 805 may receive uplink traffic from UE 701 (e.g., via RAN 710), and may forward the traffic toward DN 750. In some embodiments, UPF 805 may implement, may be implemented by, may be communicatively coupled to, and/or may otherwise be associated with UPF/PGW-U 735. In some embodiments, UPF 805 may communicate (e.g., via the N4 interface) with SMF 803, regarding user plane data processed by UPF 805 (e.g., to provide analytics or reporting information, to receive policy and/or authorization information, etc.).

PCF 807 may include one or more devices, systems, VNFs, CNFs, etc., that aggregate, derive, generate, etc. policy information associated with the 5GC and/or UEs 701 that communicate via the 5GC and/or RAN 710. PCF 807 may receive information regarding policies and/or subscriptions from one or more sources, such as subscriber databases (e.g., UDM 809, UDR 813, etc.), and/or from one or more users such as, for example, an administrator associated with PCF 807. In some embodiments, the functionality of PCF 807 may be split into multiple network functions or subsystems, such as access and mobility PCF (“AM-PCF”) 817, session management PCF (“SM-PCF”) 819, UE PCF (“UE-PCF”) 821, and so on. Such different “split” PCFs may be associated with respective SBIs (e.g., AM-PCF 817 may be associated with an Nampcf SBI, SM-PCF 819 may be associated with an Nsmpcf SBI, UE-PCF 821 may be associated with an Nuepcf SBI, and so on) via which other network functions may communicate with the split PCFs. The split PCFs may maintain information regarding policies associated with different devices, systems, and/or network functions.

NRF 811 may include one or more devices, systems, VNFs, CNFs, etc. that maintain routing and/or network topology information associated with the 5GC. For example, NRF 811 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 813 may include one or more devices, systems, VNFs, CNFs, etc. that provide user and/or subscriber information, based on which PCF 807 and/or other elements of environment 800 may determine access policies, QoS policies, charging policies, or the like. In some embodiments, UDR 813 may receive such information from UDM 809 and/or one or more other sources.

NEF 815 include one or more devices, systems, VNFs, CNFs, etc. that provide access to information, APIs, and/or other operations or mechanisms of the 5GC to devices or systems that are external to the 5GC. NEF 815 may maintain authorization and/or authentication information associated with such external devices or systems, such that NEF 815 is able to provide information, that is authorized to be provided, to the external devices or systems. Such information may be received from other network functions of the 5GC (e.g., as authorized by an administrator or other suitable entity associated with the 5GC), such as SMF 803, UPF 805, a charging function (“CHF”) of the 5GC, and/or other suitable network function. NEF 815 may communicate with external devices or systems (e.g., external devices 754) via DN 750 and/or other suitable communication pathways.

While environment 800 is described in the context of a 5GC, as noted above, environment 800 may, in some embodiments, include or implement one or more other types of core networks. For example, in some embodiments, environment 800 may be or may include a converged packet core, in which one or more elements may perform some or all of the functionality of one or more 5GC network functions and/or one or more EPC network functions. For example, in some embodiments, AMF 715 may include, may implement, may be implemented by, and/or may otherwise be associated with MME 716; SMF 803 may include, may implement, may be implemented by, and/or may otherwise be associated with SGW 717; PCF 807 may include, may implement, may be implemented by, and/or may otherwise be associated with a PCRF (e.g., PCF/PCRF 725); NEF 815 may include, may implement, may be implemented by, and/or may otherwise be associated with a SCEF (e.g., NEF/SCEF 749); and so on.

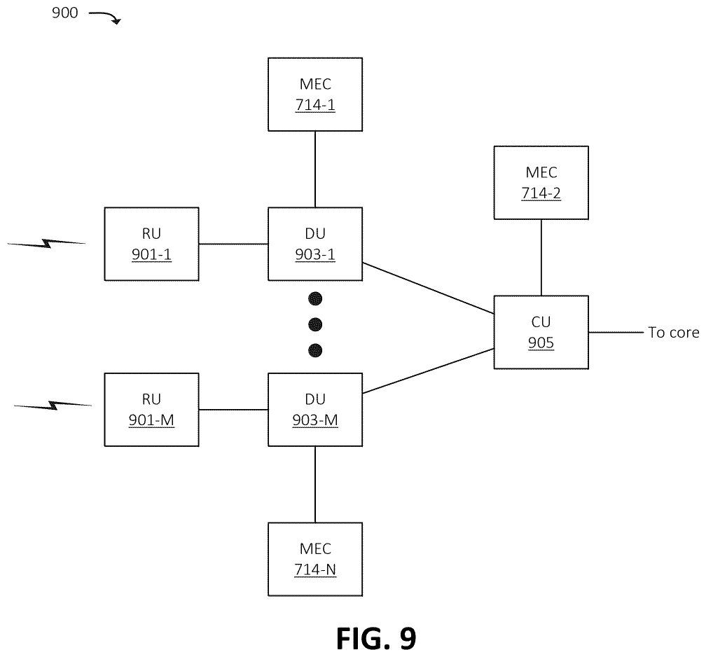

FIG. 9 illustrates an example RAN environment 900, which may be included in and/or implemented by one or more RANs (e.g., RAN 710 or some other RAN). In some embodiments, a particular RAN 710 may include one RAN environment 900. In some embodiments, a particular RAN 710 may include multiple RAN environments 900. In some embodiments, RAN environment 900 may correspond to a particular gNB 711 of RAN 710. In some embodiments, RAN environment 900 may correspond to multiple gNBs 711. In some embodiments, RAN environment 900 may correspond to one or more other types of base stations of one or more other types of RANs. As shown, RAN environment 900 may include Central Unit (“CU”) 905, one or more Distributed Units (“DUs”) 903-1 through 903-M (referred to individually as “DU 903,” or collectively as “DUs 903”), and one or more Radio Units (“RUs”) 901-1 through 901-M (referred to individually as “RU 901,” or collectively as “RUs 901”).

CU 905 may communicate with a core of a wireless network (e.g., may communicate with one or more of the devices or systems described above with respect to FIG. 8, such as AMF 715 and/or UPF 805) and/or some other device or system such as MEC 714. In the uplink direction (e.g., for traffic from UEs 701 to a core network), CU 905 may aggregate traffic from DUs 903, and forward the aggregated traffic to the core network. In some embodiments, CU 905 may receive traffic according to a given protocol (e.g., Radio Link Control (“RLC”) traffic) from DUs 903, and may perform higher-layer processing (e.g., may aggregate/process RLC packets and generate Packet Data Convergence Protocol (“PDCP”) packets based on the RLC packets) on the traffic received from DUs 903.

CU 905 may receive downlink traffic (e.g., traffic from the core network, traffic from a given MEC 714, etc.) for a particular UE 701, and may determine which DU(s) 903 should receive the downlink traffic. DU 903 may include one or more devices that transmit traffic between a core network (e.g., via CU 905) and UE 701 (e.g., via a respective RU 901). DU 903 may, for example, receive traffic from RU 901 at a first layer (e.g., physical (“PHY”) layer traffic, or lower PHY layer traffic), and may process/aggregate the traffic to a second layer (e.g., upper PHY and/or RLC). DU 903 may receive traffic from CU 905 at the second layer, may process the traffic to the first layer, and provide the processed traffic to a respective RU 901 for transmission to UE 701.

RU 901 may include hardware circuitry (e.g., one or more RF transceivers, antennas, radios, and/or other suitable hardware) to communicate wirelessly (e.g., via an RF interface) with one or more UEs 701, one or more other DUs 903 (e.g., via RUs 901 associated with DUs 903), and/or any other suitable type of device. In the uplink direction, RU 901 may receive traffic from UE 701 and/or another DU 903 via the RF interface and may provide the traffic to DU 903. In the downlink direction, RU 901 may receive traffic from DU 903, and may provide the traffic to UE 701 and/or another DU 903.

One or more elements of RAN environment 900 may, in some embodiments, be communicatively coupled to one or more MECs 714. For example, DU 903-1 may be communicatively coupled to MEC 714-1, DU 903-M may be communicatively coupled to MEC 714-N, CU 905 may be communicatively coupled to MEC 714-2, and so on. MECs 714 may include hardware resources (e.g., configurable or provisionable hardware resources) that may be configured to provide services and/or otherwise process traffic to and/or from UE 701, via a respective RU 901.

For example, DU 903-1 may route some traffic, from UE 701, to MEC 714-1 instead of to a core network via CU 905. MEC 714-1 may process the traffic, perform one or more computations based on the received traffic, and may provide traffic to UE 701 via RU 901-1. As discussed above, MEC 714 may include, and/or may implement, some or all of the functionality described above with respect to UPF 805, AF 730, and/or one or more other devices, systems, VNFs, CNFs, etc. In this manner, ultra-low latency services may be provided to UE 701, as traffic does not need to traverse DU 903, CU 905, links between DU 903 and CU 905, and an intervening backhaul network between RAN environment 900 and the core network.

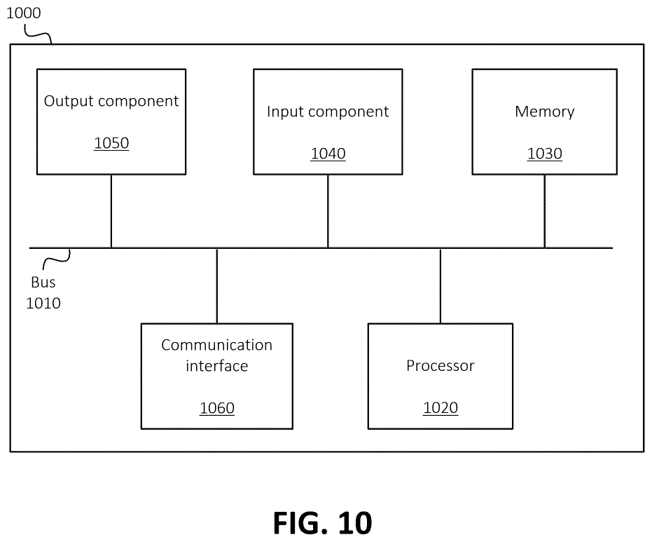

FIG. 10 illustrates example components of device 1000. One or more of the devices described above may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, a set of provisioned hardware resources of a cloud computing system, a graphics processing unit (“GPU”), a GPU-based processing unit, a neural processing unit (“NPU”), or other suitable type of hardware that interprets and/or executes instructions (e.g., processor-executable instructions). In some embodiments, processor 1020 may be or may include one or more hardware processors. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000 and/or other receives or detects input from a source external to input component 1040, such as a touchpad, a touchscreen, a keyboard, a keypad, a button, a switch, a microphone or other audio input component, etc. In some embodiments, input component 1040 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1050 may include a mechanism that outputs information to the operator, such as a display, a speaker, one or more light emitting diodes (“LEDs”), etc.

Communication interface 1060 may include any transceiver-like mechanism that enables device 1000 to communicate with other devices and/or systems (e.g., via RAN 710, RAN 712, DN 750, etc.). For example, communication interface 1060 may include an Ethernet interface, an optical interface, a coaxial interface, or the like. Communication interface 1060 may include a wireless communication device, such as an infrared (“IR”) receiver, a Bluetooth^{®}radio, or the like. The wireless communication device may be coupled to an external device, such as a cellular radio, a remote control, a wireless keyboard, a mobile telephone, etc. In some embodiments, device 1000 may include more than one communication interface 1060. For instance, device 1000 may include an optical interface, a wireless interface, an Ethernet interface, and/or one or more other interfaces.

Device 1000 may perform certain operations relating to one or more processes described above. Device 1000 may perform these operations in response to processor 1020 executing instructions, such as software instructions, processor-executable instructions, etc. stored in a computer-readable medium, such as memory 1030. A computer-readable medium may be defined as a non-transitory memory device. A memory device may include space within a single physical memory device or spread across multiple physical memory devices. The instructions may be read into memory 1030 from another computer-readable medium or from another device. The instructions stored in memory 1030 may be processor-executable instructions that cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-6), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
maintain one or more policies associated with a particular User Equipment (“UE”);
provide, based on maintaining the one or more policies associated with the particular UE and to a particular Binding Support Function (“BSF”) of a wireless network, an indication associating the device with the particular UE; and
provide, to a Unified Data Repository (“UDR”) of the wireless network, an association between the particular UE and the particular BSF, wherein the UDR provides information associating the particular UE and the particular BSF to one or more Network Functions (“NFs”) of the wireless network.

2. The device of claim 1, wherein the particular BSF is a particular BSF instance of a plurality of BSF instances included in the wireless network.

3. The device of claim 1, wherein the device includes a Policy Control Function (“PCF”) of the wireless network.

4. The device of claim 1, wherein providing the association between the particular UE and the particular BSF includes providing, to the UDR, a first identifier of the particular UE and a second identifier of the particular BSF.

5. The device of claim 1, wherein the particular BSF maintains information associating the device with the particular UE.

6. The device of claim 5, wherein the particular BSF maintains information indicating that the device maintains the one or more policies associated with the particular UE.

7. The device of claim 1, wherein the device includes a first Policy Control Function (“PCF”), and wherein the one or more NFs include a second PCF.

8. A non-transitory computer-readable medium, storing a plurality of processor-executable instructions to:
maintain, by a device, one or more policies associated with a particular User Equipment (“UE”);
provide, based on maintaining the one or more policies associated with the particular UE and to a particular Binding Support Function (“BSF”) of a wireless network, an indication associating the device with the particular UE; and
provide, to a Unified Data Repository (“UDR”) of the wireless network, an association between the particular UE and the particular BSF, wherein the UDR provides information associating the particular UE and the particular BSF to one or more Network Functions (“NFs”) of the wireless network.

9. The non-transitory computer-readable medium of claim 8, wherein the particular BSF is a particular BSF instance of a plurality of BSF instances included in the wireless network.

10. The non-transitory computer-readable medium of claim 8, wherein the device includes a Policy Control Function (“PCF”) of the wireless network.

11. The non-transitory computer-readable medium of claim 8, wherein providing the association between the particular UE and the particular BSF includes providing, to the UDR, a first identifier of the particular UE and a second identifier of the particular BSF.

12. The non-transitory computer-readable medium of claim 8, wherein the particular BSF maintains information associating the device with the particular UE.

13. The non-transitory computer-readable medium of claim 12, wherein the particular BSF maintains information indicating that the device maintains the one or more policies associated with the particular UE.

14. The non-transitory computer-readable medium of claim 8, wherein the device includes a first Policy Control Function (“PCF”), and wherein the one or more NFs include a second PCF.

15. A method, comprising:
maintaining, by a device, one or more policies associated with a particular User Equipment (“UE”);
providing, based on maintaining the one or more policies associated with the particular UE and to a particular Binding Support Function (“BSF”) of a wireless network, an indication associating the device with the particular UE; and
providing, to a Unified Data Repository (“UDR”) of the wireless network, an association between the particular UE and the particular BSF, wherein the UDR provides information associating the particular UE and the particular BSF to one or more Network Functions (“NFs”) of the wireless network.

16. The method of claim 15, wherein the particular BSF is a particular BSF instance of a plurality of BSF instances included in the wireless network.

17. The method of claim 15, wherein the device includes a Policy Control Function (“PCF”) of the wireless network.

18. The method of claim 15, wherein providing the association between the particular UE and the particular BSF includes providing, to the UDR, a first identifier of the particular UE and a second identifier of the particular BSF.

19. The method of claim 15, wherein the particular BSF maintains information indicating that the device maintains the one or more policies associated with the particular UE.

20. The method of claim 15, wherein the device includes a first Policy Control Function (“PCF”), and wherein the one or more NFs include a second PCF.
